(19) United States
(12) Patent Application Publication
(10) Pub. No.: US 2002/0058235 A1
(43) Pub. Date: May 16, 2002

(54) Jack switch talking block

(76) Inventor: Mitchell Elliot Dinnerstein, Jackson, NJ (US)

Correspondence Address: Mitchell Dinnerstein, 18 Lawrencen St., Jackson, NJ, 08527, US

(21) Appl. No.: 09/797,060

(22) Filed: Apr. 26, 2001

Related U.S. Application Data
(60) Provisional application No. 60/176,036, filed on Feb. 29, 2000.

(51) Int. Cl. G09B 19/00

(52) U.S. Cl. 434/171; 434/159; 434/156

(57) ABSTRACT

The Jack Switch Talking Block is an educational toy for young children. The Jack Switch is the means by witch six sided blocks, normal children's play blocks, can be made to speak to the children. It must be made of a size shape and construction to meet or exceed all the laws that apply to such a product. It must be safe for the children to play with.

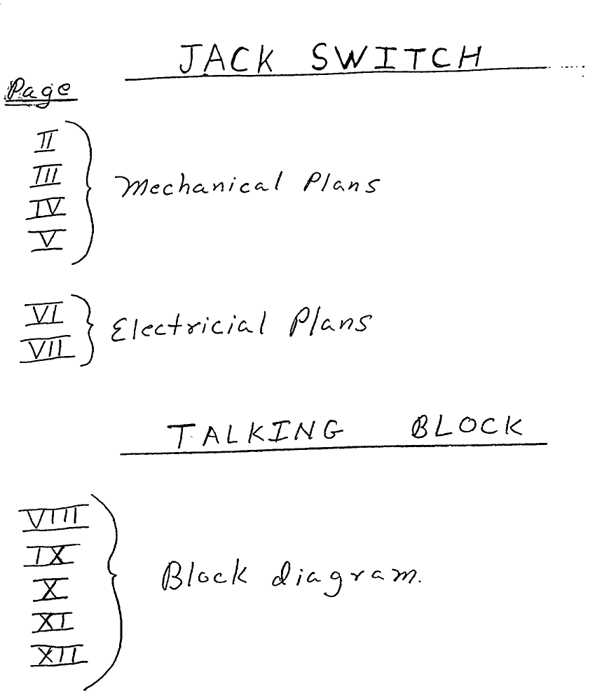

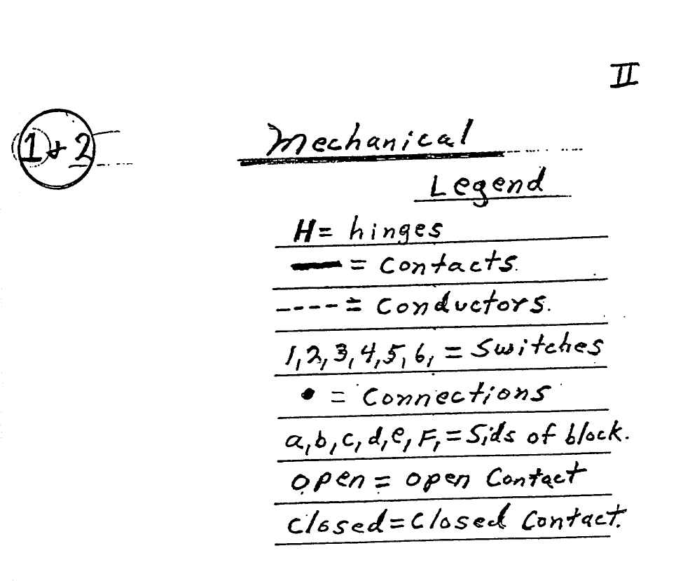

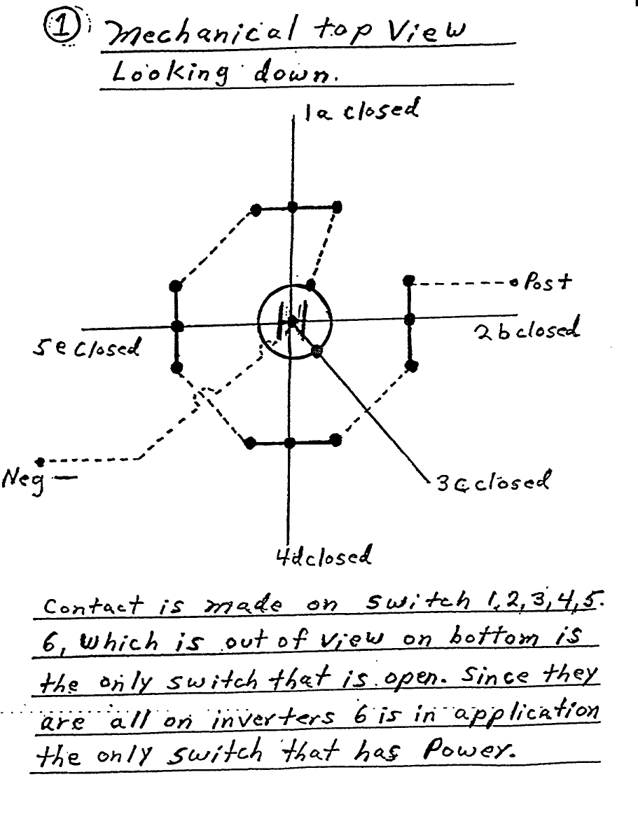

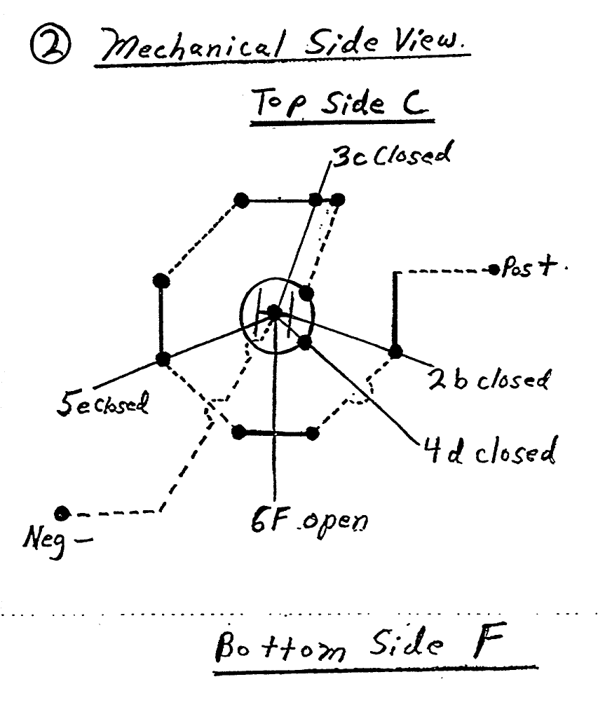

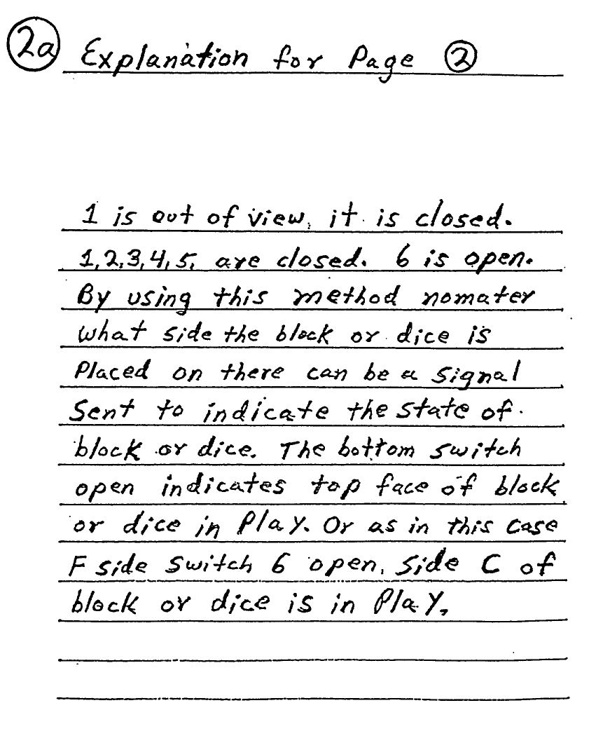

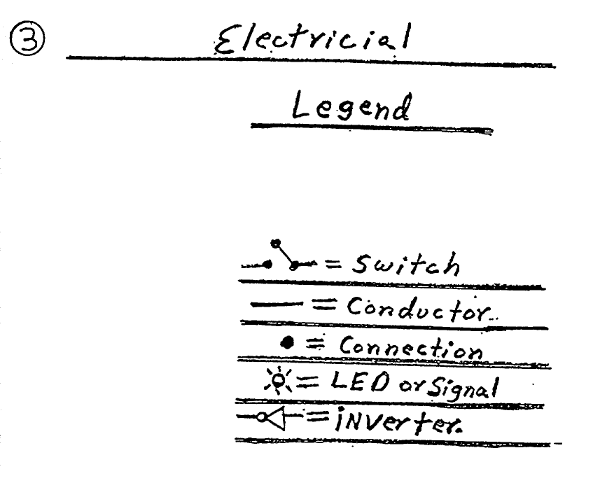

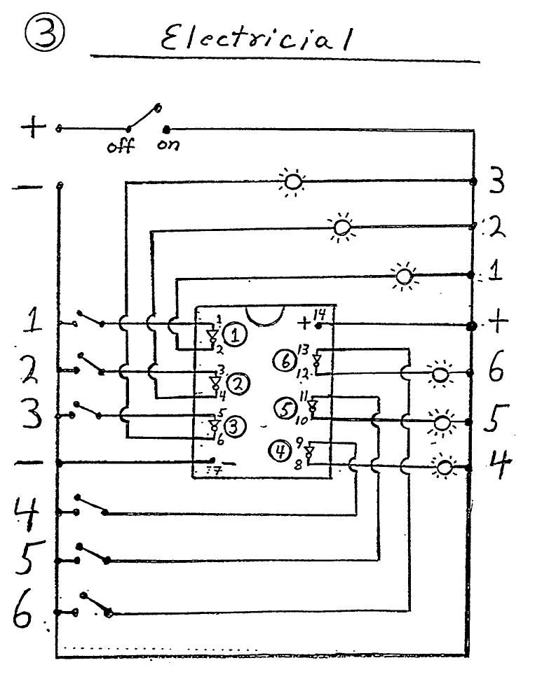

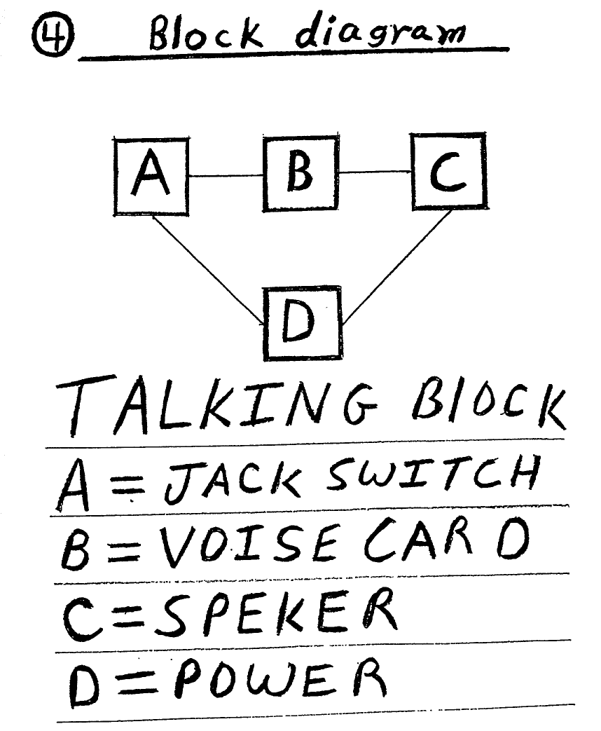

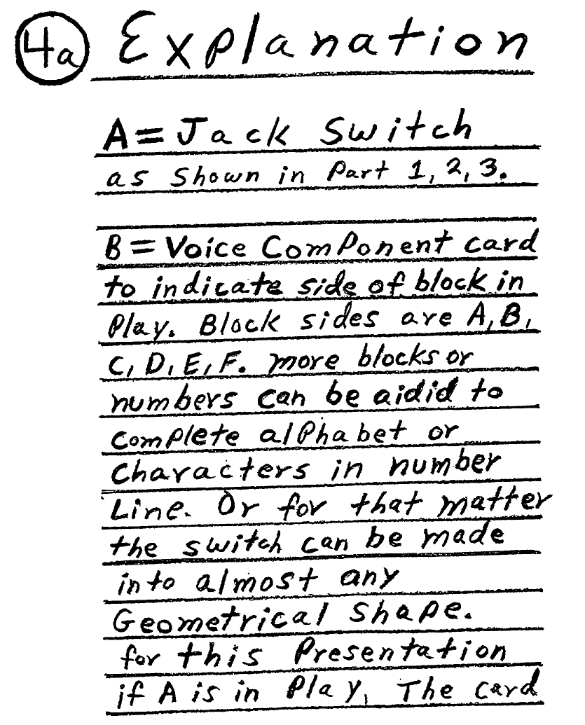

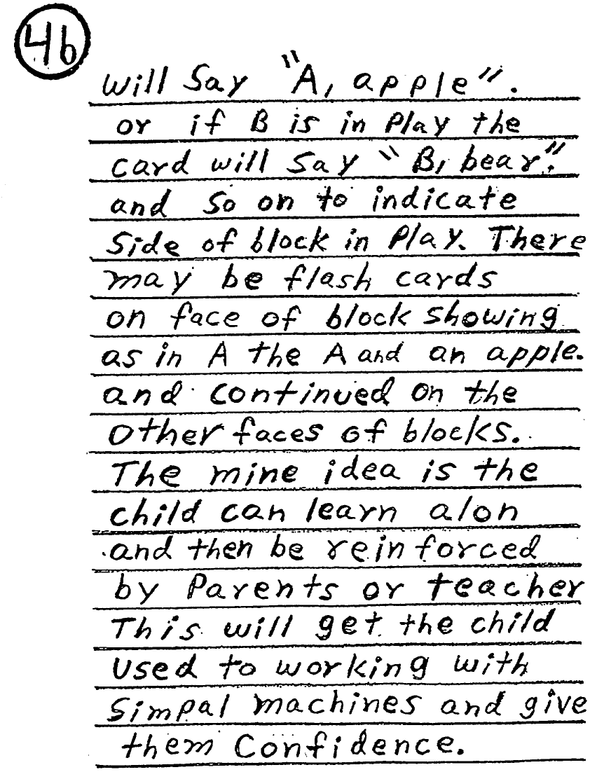

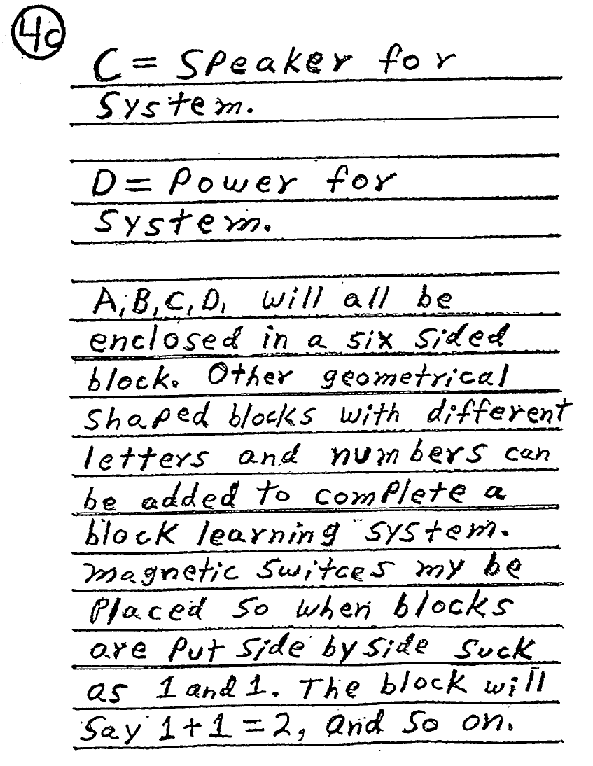

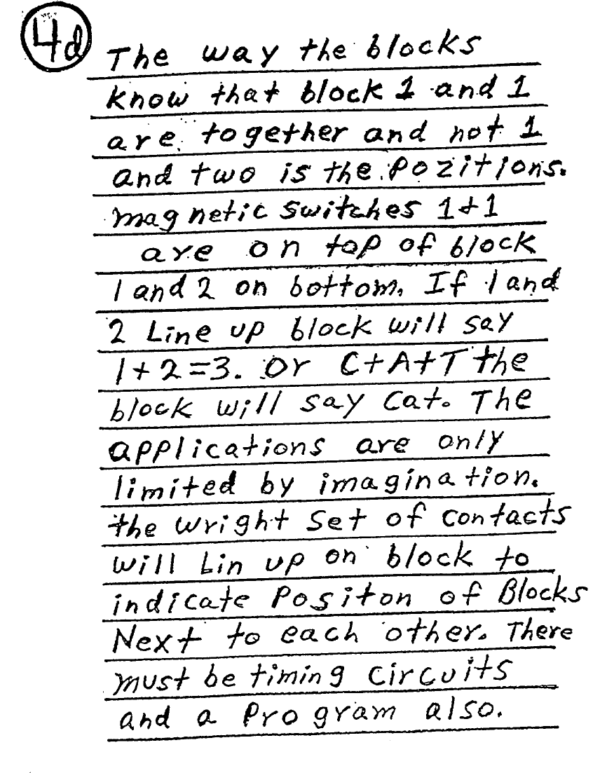

The jack switch can be used in other applications and with simple modifications in other geometric shapes. With the addition of simple magnetic switches in different positions on the blocks they can be made to be gangable to expand there functions. Such as placing them together to spell words or do math computations. A timing circuit and program must be added to the hardware I listed in the prints.

This can be expanded by placing the blocks on a magnetic grid mouse pad with block dividers and fasteners so the blocks can go up and out. With a computer and a program a three dimensional scabble type game for older children or adults will work.

A signal device and receiving unit can be added and will enable the Jack Switch Talking Block to be rolled on a mouse pad and a signal received on a computer to play board games on the computer or a slot type craps machine. There by enabling a person to role dice in real world and move characterin in the varietal world. No mater what the application all laws that apply to such a product must be met or exceeded and the product must be safe.

The Jack Switch Talking Block is an educational toy for young children. The Jack Switch is the means by witch a Six sided blocks, normal chalderns play blocks, can be made to speak to the children. The way it works is explained on page 2 through 7 marked in roman numerals on the print's. The jack switch must be made of quality materials able to withstand the usage of the children. It must comply to or exceed to all safety laws that apply to such a dives.

The Talking Block is explained on page 8 through 12 marked in roman numerals on the prints. It must be of a size weight and construction to meat or exceed all safety laws that apply to such a product. It must be made to supply a long time of safe fun and leaning for the children.

The Jack Switch can be used in other applications and with simple modifications in other geometric shapes. With the addition of simple magnetic switches in different positions on the blocks, they can be made to be gang able to expand there function. Such as ganging them to spell words. Or placing them on a surface of a magnetic gird mouse pad to produce a hands on Scabble like game, it can not only be made to be played on board but by using the switches in the block be made to spell words, block on top of block to go up. Mechanical fasteners can be made to go out ones up all connected to a computer for spell check. Or if only one person is playing to play against the computer. Another application is dice and a mouse pad that can be made to be used for computer board games. Rolling the dice in the real world and the Caricatures move in the virtual world. This can be easily accomplished by adding an Frequency switches or other type of sending unit in the dice to the pad. The applications of the switch are infinite. Self instructional building blocks. An automated hand on crapes slot like machine. If the switch can be made chemically It can be used to make a directional medicine that will only effect that part of the body it needs to then become innate. Anything modular can be made to know direction and instruct itself or it user through programming if there is gravity or another force applied.

1. What I clame as my invention, the mechanical construction of the Jack Switch.

2. I also clame as my invention the consept of the tolking block. Even if a different kind of switch then my jack switch is used.

3. I also claim as my invention the consept of placing a signal sending divice in the blocks, or other geometric shapes, and a receiving unit in a mouse pad, or other type computer receving unit, to play board games that will enableing a player to role dice, letter number or building blocks in the real world and have characters move in the virtual world.
